(19) United States
(12) Patent Application Publication
(10) Pub. No.: US 2025/0284684 A1
(43) Pub. Date: Sep. 11, 2025

(54) SQL PROCESSING METHOD AND APPARATUS, DEVICE, MEDIUM, AND PRODUCT

(71) Applicant: Beijing Volcano Engine Technology Co., Ltd., Beijing (CN)

(72) Inventors: Luyang Cao, Beijing (CN); Zhenyi Zhao, Beijing (CN); Zhijuan Yan, Beijing (CN); Nao Xu, Beijing (CN)

(21) Appl. No.: 19/064,683

(22) Filed: Feb. 26, 2025

(30) Foreign Application Priority Data
Mar. 7, 2024 (CN) 202410263617.6

(51) Int. Cl. G06F 16/2452; G06F 16/242

(52) U.S. Cl. CPC G06F 16/24528; G06F 16/242

(57) ABSTRACT

The present application discloses a SQL processing method, an apparatus, a device, a medium and a product. The method includes: after a SQL to-be-processed is acquired, performing parse processing on the SQL to-be-processed to obtain a graphic representation corresponding to the SQL to-be-processed, so that the graphic representation is used for describing an execution process of the SQL to-be-processed; then, when the execution process includes processing logic of at least one candidate field and the at least one candidate field includes a target field, cropping a graphic representation corresponding to the target field from the graphic representation corresponding to the SQL to-be-processed, so that the graphic representation corresponding to the target field is used for describing the processing logic of the target field; finally, performing inverse parse processing on the graphic representation corresponding to the target field to obtain a SQL corresponding to the target field.

### CROSS-REFERENCE TO RELATED APPLICATION(S)

This application claims priority to Chinese Application No. 202410263617.6 filed Mar. 7, 2024, the disclosure of which is incorporated herein by reference in its entirety.

### FIELD

The present application relates to the field of computer technology, and in particular, to a SQL processing method and apparatus, a device, a medium, and a product.

### BACKGROUND

Structured Query Language (SQL), such as Hive SQL, is a commonly used query language. However, due to the high complexity of SQL, it is challenging for some application fields, such as fields related to data lakes and/or data warehouses, to determine the processing logic of a certain field from SQL.

### SUMMARY

In order to solve the above technical problems, the present application provides a SQL processing method, an apparatus, a device, a medium and a product.

In order to achieve the above object, the technical solutions provided by the present application are as follows:

The present application provides a SQL processing method, and the method includes:
performing parse processing on a SQL to-be-processed to obtain a graphic representation corresponding to the SQL to-be-processed after the SQL to-be-processed is acquired, where the graphic representation is used for describing an execution process of the SQL to-be-processed, the execution process includes processing logic of at least one candidate field, and the at least one candidate field includes a target field;
cropping a graphic representation corresponding to the target field from the graphic representation corresponding to the SQL to-be-processed, where the graphic representation corresponding to the target field is used for describing the processing logic of the target field; and
performing inverse parse processing on the graphic representation corresponding to the target field to obtain a SQL corresponding to the target field.

In one possible implementation, a process for determining the graphic representation corresponding to the SQL to-be-processed includes: converting the SQL to-be-processed into an abstract syntax tree corresponding to the SQL to-be-processed; converting the abstract syntax tree corresponding to the SQL to-be-processed into the graphic representation corresponding to the SQL to-be-processed;
a process for determining the SQL corresponding to the target field includes: converting the graphic representation corresponding to the target field into an abstract syntax tree corresponding to the target field; converting the abstract syntax tree corresponding to the target field into the SQL corresponding to the target field.

In one possible implementation, cropping the graphic representation corresponding to the target field from the graphic representation corresponding to the SQL to-be-processed includes: extracting an associated part of the target field from the graphic representation corresponding to the SQL to-be-processed; and performing at least one type of simplification processing on the associated part to obtain the graphic representation corresponding to the target field, where the at least one type of simplification processing includes one or more of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

In one possible implementation, the invalid connection cropping processing includes: in response to the associated part including left connection logic, and right table processing logic in the left connection logic having no influence on the target field, deleting the right table processing logic from the associated part; and in response to the associated part including right connection logic, and left table processing logic in the right connection logic having no influence on the target field, deleting the left table processing logic from the associated part.

In one possible implementation, the nested selection combination processing includes: in response to the multi-layer nested selection logic in the associated part satisfying a predicate combination condition, combining at least two conditions in the multi-layer nested selection logic; and in response to the multi-layer nested selection logic in the associated part satisfying an invalid subquery combination condition, combining at least two layers of selection logic in the multi-layer nested selection logic.

In one possible implementation, the method further includes: displaying the SQL corresponding to the target field and the graphic representation corresponding to the target field.

In one possible implementation, the method further includes: after the obtaining the SQL corresponding to the target field,
updating the SQL to-be-processed according to the SQL corresponding to the target field and a production SQL of a physical table in the SQL corresponding to the target field, and returning to continue performing the step of performing parse processing on the SQL to-be-processed, until a preset stop condition is satisfied, where the physical table is obtained by executing the production SQL.

In one possible implementation, updating the SQL to-be-processed according to the SQL corresponding to the target field and the production SQL of the physical table in the SQL corresponding to the target field includes:
performing deformation processing on the production SQL of the physical table to obtain a subquery statement corresponding to the physical table, where processing logic described by the subquery statement is consistent with processing logic described by the production SQL; and
replacing the physical table in the SQL corresponding to the target field with the subquery statement corresponding to the physical table to obtain an updated SQL to-be-processed.

The present application provides a SQL processing apparatus, including:
a parsing unit, configured to perform parse processing on a SQL to-be-processed to obtain a graphic representation corresponding to the SQL to-be-processed after the SQL to-be-processed is acquired, where the graphic representation is used for describing an execution process of the SQL to-be-processed, the execution process includes processing logic of at least one candidate field, and the at least one candidate field includes a target field;
a cropping unit, configured to crop a graphic representation corresponding to the target field from the graphic representation corresponding to the SQL to-be-processed, where the graphic representation corresponding to the target field is used for describing the processing logic of the target field; and
an inverse parsing unit, configured to perform inverse parse processing on the graphic representation corresponding to the target field to obtain a SQL corresponding to the target field.

The present application provides an electronic device, the device includes: a processor and a memory;
the memory is configured to store instructions or a computer program; and
the processor is configured to execute the instructions or the computer program in the memory, to cause the electronic device to execute the SQL processing method provided by the present application.

The present application provides a computer-readable medium, the computer-readable medium stores instructions or a computer program, and when the instructions or the computer program are run on a device, the device is caused to execute the SQL processing method provided by the present application.

The present application provides a computer program product, which includes a computer program carried on a non-transitory computer-readable medium, and the computer program includes program codes for performing the SQL processing method provided by the present application.

### BRIEF DESCRIPTION OF THE DRAWINGS

In order to more clearly explain the technical solutions in the embodiments of the present application or in the related art, the drawings required in describing the embodiments or the related art will be briefly introduced below. Obviously, the drawings in the following description are only some embodiments recorded in the present application. For those of ordinary skill in the art, other drawings can be obtained based on these drawings without creative efforts.

FIG. 1 is a flowchart of a SQL processing method provided by an embodiment of the present application;

FIG. 2 is a schematic diagram of a graphic representation corresponding to a target field provided by an embodiment of the present application;

FIG. 3 is a schematic diagram of upward exploration of a physical table provided by an embodiment of the present application;

FIG. 4 is a schematic structural diagram of a SQL processing apparatus provided by an embodiment of the present application; and

FIG. 5 is a schematic structural diagram of an electronic device provided by an embodiment of the present application.

### DETAILED DESCRIPTION OF EMBODIMENTS

In order to make those skilled in the art better understand the solutions of the present application, the technical solutions in the embodiments of the present application will be clearly and completely described below with reference to the drawings in the embodiments of the present application. Obviously, the described embodiments are only a part of the embodiments of the present application, but not all of the embodiments. Based on the embodiments in the present application, all other embodiments obtained by those of ordinary skill in the art without creative efforts fall within the protection scope of the present application.

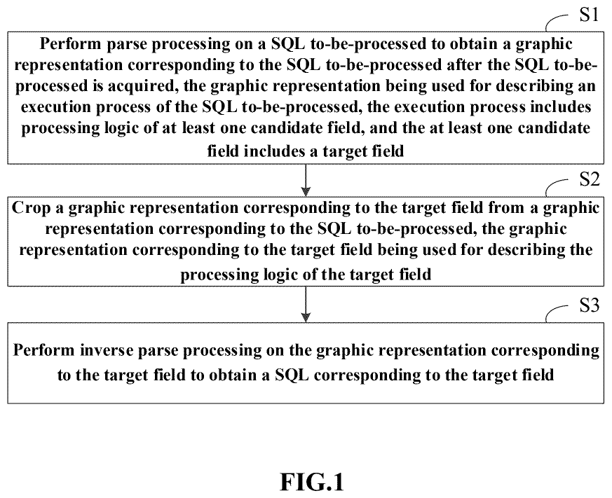

In order to better understand the technical solutions provided by the present application, the SQL processing method provided by the present application will be described below with reference to some drawings. As shown in FIG. 1, the SQL processing method provided by the embodiment of the present application includes the following S1-S3. FIG. 1 is a flowchart of a SQL processing method provided by an embodiment of the present application.

S1: performing parse processing on a SQL to-be-processed to obtain a graphic representation corresponding to the SQL to-be-processed after the SQL to-be-processed is acquired, where the graphic representation is used for describing an execution process of the SQL to-be-processed, the execution process includes processing logic of at least one candidate field, and the at least one candidate field includes a target field.

The SQL to-be-processed refers to a SQL required to be used when determining the relevant logic of a certain field, such as Hive SQL, and the SQL to-be-processed may include at least one statement, such as 100 statements. In addition, the implementation of the SQL to-be-processed is not limited in the present application. For example, the SQL to-be-processed may refer to a SQL input by a user, such as a piece of code including multiple SQL statements. For another example, the SQL to-be-processed may refer to a SQL obtained in a certain way.

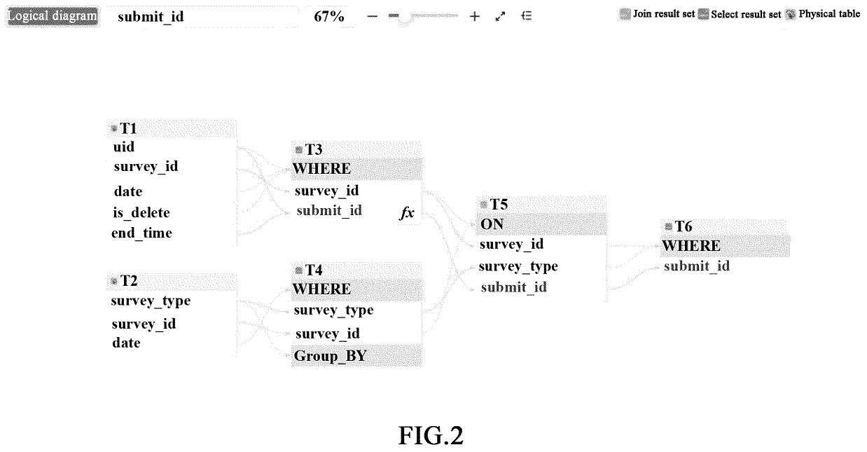

The graphic representation corresponding to the SQL to-be-processed is used for describing an execution process of the SQL to-be-processed, so that the graphic representation can intuitively describe the execution process of the SQL to-be-processed in a visual manner. For example, the graphic representation can intuitively describe the execution process of the SQL to-be-processed in a manner of a chart similar to that shown in FIG. 2, so that the graphic representation can describe various tables, various fields, relationships between different tables and different fields, processing logic of each field, and the like involved in executing the SQL to-be-processed in the visual manner. It can be seen that, in a possible implementation, the graphic representation corresponding to the SQL to-be-processed can be used for describing the processing logic of at least one candidate field, so that the graphic representation corresponding to the SQL to-be-processed can represent how to process these candidate fields when the SQL to-be-processed is executed. The at least one candidate field is used for representing some or all of the fields involved in executing the SQL to-be-processed. An ith candidate field refers to an ith field involved in executing the SQL to-be-processed, such as a field submit_id shown in FIG. 2. The processing logic of the ith candidate field is used for describing how to process the ith candidate field when the SQL to-be-processed is executed, so that the processing logic of the ith candidate field can represent the processing caliber and chain of the ith candidate field when the SQL to-be-processed is executed. i is a positive integer, i≤I, and I is a positive integer, where I represents the number of fields in the at least one candidate field, such as the number of all fields involved in executing the SQL to-be-processed.

In addition, the present application does not limit the acquisition manner of the graphic representation corresponding to the SQL to-be-processed. For example, it can be implemented by using any existing or future method capable of processing a SQL into visual data, such as a method of a chart similar to that shown in FIG. 2.

For another example, in order to achieve better SQL processing effect, the present application further provides a possible implementation of the process for acquiring the graphic representation corresponding to the SQL to-be-processed. In this implementation, the process for acquiring the graphic representation corresponding to the SQL to-be-processed may specifically include the following steps 11-12.

Step 11: converting the SQL to-be-processed into an abstract syntax tree (Abstract Syntax Tree, AST) corresponding to the SQL to-be-processed.

It should be noted that the implementation of the above step 11 is not limited in the present application. For example, it may specifically be: performing syntax parsing on the SQL to-be-processed to obtain the abstract syntax tree corresponding to the SQL to-be-processed. In addition, the implementation of the syntax parsing is not limited in the present application. For example, it can be implemented by using any existing or future method capable of converting a SQL into an AST, such as a method implemented by using Apache Calcite.

It can be seen that, in a possible implementation, the above step 11 may specifically be: performing syntax parsing on the SQL to-be-processed by using Apache Calcite to obtain the abstract syntax tree corresponding to the SQL to-be-processed. Apache Calcite is a dynamic data management framework, and the Apache Calcite includes many pre-built databases and query engines, so that the Apache Calcite can be used to build various types of databases and data processing systems, and the Apache Calcite can be used to convert SQL statements into ASTs.

Step 12: converting the abstract syntax tree corresponding to the SQL to-be-processed into a graphic representation corresponding to the SQL to-be-processed.

It should be noted that the implementation of the above step 12 is not limited in the present application. For example, it can be implemented by using any existing or future method capable of converting an AST into visual data, such as a method implemented by using a custom visualization algorithm.

For another example, in order to achieve better SQL processing effect, the above step 12 may specifically include the following steps 121-123.

Step 121: determining a plurality of tables corresponding to the SQL to-be-processed and an association relationship between the plurality of tables according to the abstract syntax tree corresponding to the SQL to-be-processed.

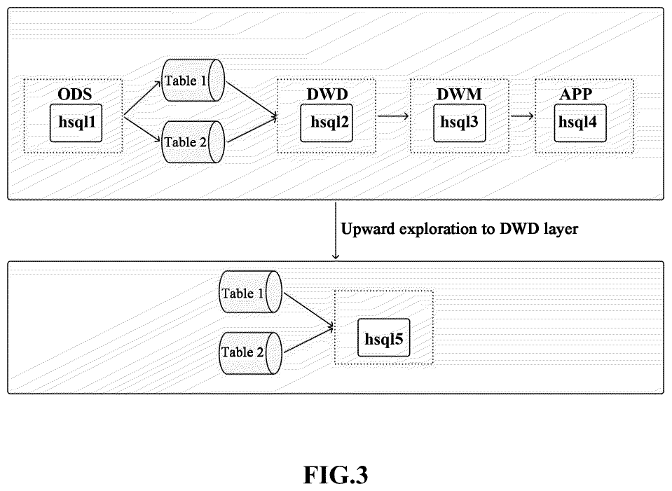

The plurality of tables are used for representing all or part of the tables involved in executing the SQL to-be-processed, such as physical tables and intermediate processing results. It should be noted that a physical table refers to a table stored in a database, such as various physical tables shown in FIG. 2 or tables stored in various databases shown in FIG. 3. An intermediate processing result refers to a result obtained by processing some tables, such as a join result set and a select result set shown in FIG. 2.

In addition, the implementation of the plurality of tables in the above step 121 is not limited in the present application. For example, in a possible implementation, the plurality of tables may include some or all of the types shown in the following Table 1, so that the plurality of tables can comprehensively represent the tables involved in executing the SQL to-be-processed, such as the tables stored in the database and the tables generated by certain processing, which is beneficial to the improvement of the SQL processing effect.

TABLE 1
Some table types and related information

| Table type | Related information |
|---|---|
| Hive table (including | A type of physical table |
| temporary table) | |
| Hive view | Another type of physical table |
| With as result set | A result obtained by performing processing with the aid of a with as statement |
| Select result set | A result obtained by performing processing with the aid of a select statement |
| Select result set | A result obtained by performing processing with the aid of a select statement |
| Inline table | Inline table |
| Aggregation result set | A result obtained by performing aggregation processing |
| Join result | A result obtained by performing a certain connection processing, where the |
| | connection processing is used for generating a wide table based on two tables. In |
| | addition, the connection processing is not limited in the present application, for |
| | example, it may include one or more of: left join (left outer join), left semi join, |
| | join (inner join), cross join, right join (right outer join), and full join (full outer |
| | join). |
| Union result | A result obtained by performing a certain union processing, and the union |
| | processing is not limited in the present application, for example, it may include one |
| | or more of: union all and union distinct. |
| Intersect result | A result obtained by performing a certain intersection processing, and the |
| | intersection processing is not limited in the present application, for example, it may |
| | include at least one of: intersect all and intersect distinct. |
| Except result | A result obtained by performing a certain difference processing, and the difference |
| | processing is not limited in the present application, for example, it may include at |
| | least one of: except all and except distinct. |
| Lateral view result set | A result obtained by performing processing with the aid of a lateral view statement |

In addition, for the “association relationship between the plurality of tables” in the above step 121, the association relationship is used for describing the relationship between different tables, such as an input-output relationship, so that the association relationship can represent the upstream and downstream relationship between these tables.

In addition, the implementation of the above step 121 is not limited in the present application. For example, it may specifically be: after the abstract syntax tree corresponding to the SQL to-be-processed is acquired, semantic parsing can be performed on the abstract syntax tree to obtain the plurality of tables corresponding to the SQL to-be-processed and the association relationship between the plurality of tables, so that these pieces of information can represent some tables involved in executing the SQL to-be-processed and the input-output relationship between these tables.

Step 122: determining a logical relationship between at least two fields corresponding to the SQL to-be-processed according to the abstract syntax tree corresponding to the SQL to-be-processed, the plurality of tables, and the association relationship between the plurality of tables, so that the logical relationship can represent how one field is obtained from another field through processing.

The at least two fields refer to the fields involved in the plurality of tables, so that the at least two fields can represent all or part of the fields involved in executing the SQL to-be-processed.

In addition, for the at least two fields, the logical relationship between the at least two fields is used for representing an inference logic existing between different fields, so that the logical relationship can represent the relationship between various fields in different tables involved in executing the SQL to-be-processed in more detail. For example, a field in a downstream table can be obtained by processing one or more fields in an upstream table.

In addition, the implementation of the logical relationship in the above step 122 is not limited in the present application. For example, it may include some or all of the logical relationships shown in the following Table 2.

TABLE 2
Some logical relationship types and related information

| Relationship type | Related information |
|---|---|
| Upstream table filtering | The upstream table filtering logic refers to filtering logic (where expression) |
| logic | performed on the upstream table when the downstream table is obtained by |
| | processing the upstream table. Moreover, in an intuitive graphic representation, the |
| | field used in the filtering condition generates a connection with “row filtering |
| | logic”, such as the expression “where”. |
| Join logic | The join logic refers to association logic (on expression) performed when multiple |
| | upstream tables are connected. Moreover, in an intuitive graphic representation, the |
| | field used in the join logic generates a connection with “join logic”, such as the |
| | expression “on”. |
| Lateral view logic | The lateral view logic refers to the logic (lateral view expression) of the lateral |
| | view of the upstream table, and in an intuitive graphic representation, the field used |
| | in the lateral view logic generates a connection with “lateral view logic”, such as |
| | the expression “lateral view”. |
| Field processing logic | The field processing logic is used for processing one or more rows of data, and the |
| | field processing logic includes a user defined function (UDF), a user defined table- |
| | generating functions (UDTF), and a user defined aggregation function (UDAF). |
| Result processing logic | The result processing logic refers to logic (order by/having/limit, etc.) for sorting |
| | and filtering the processing result. Moreover, in an intuitive graphic representation, |
| | a new line of “result sorting and filtering logic” is added, so that the field used in |
| | the result processing logic generates a connection with the “result processing |
| | logic”. In addition, the result processing logic includes sorting logic and filtering |
| | logic. The sorting logic may include order by, sort by, cluster by, distribute by, |
| | window, and the like. the filtering logic may include having and limit. |

It should be noted that, for the UDF shown in Table 2 above, if no UDTF/UDAF occurs in the processing process from the upstream table to the downstream table, it may be considered as a UDF, and in an intuitive graphic representation, the upstream field to the downstream field involved in the UDF generates a connection. In addition, if the upstream field is processed by a UDF function to obtain the downstream field, an identifier, such as an icon, of an abbreviation of a UDF function name is displayed on the right side of the downstream field; if there is a UDF nesting, only the outermost UDF needs to be displayed. In addition, since there are too many UDF functions, only common UDFs need to be displayed as abbreviations, and the others can be displayed as fx shown in FIG. 2. In addition, if the upstream field does not need to be processed by the UDF to obtain the downstream field, the right side of the downstream field is empty. Furthermore, the UDF includes two categories: no processing and processing. Processing may specifically include data type conversion, arithmetic operations (such as addition, subtraction, multiplication, and division), character string processing (such as length, splicing, interception, replacement, and other character string processing), conditional statements (such as if, case, and other conditional statements), window functions (such as row_number, rank, dense_rank, and other window functions), and other UDF functions.

It should also be noted that, for the UDTF shown in Table 2 above, if the UDTF occurs in the processing logic from the upstream table to the downstream table, it can be considered as UDTF processing (note: the UDTF used with the lateral view is counted as the lateral view logic, and only the UDTF used after select is limited here); moreover, in the intuitive graphic representation, a new line of “udtf logic” is added, so that the field used in the UDTF logic is connected with the “UDTF logic”, and the field produced by the UDTF is connected with its upstream field.

It should be further noted that, for the UDAF shown in Table 2 above, if the UDAF occurs in the processing logic from the upstream table to the downstream table, it can be considered as UDAF processing; moreover, if there is group by logic, a new line of “group by logic” is added, so that the upstream field used in the group by logic is connected with the “group by logic”. In addition, if the upstream field is processed by a UDAF function to obtain the downstream field, an icon of an abbreviation of a UDAF function name is displayed on the right side of the downstream field; if there is a UDAF and UDF nesting, only the outermost function needs to be displayed. In addition, since there are too many UDAF functions, only common UDAFs need to be displayed as abbreviations, and the others can be displayed as fx shown in FIG. 2. UDAFs that need to display specific abbreviations: max, count, min, avg, sum, etc.

In addition, the implementation of the above step 122 is not limited in the present application. For example, it may specifically be: after the abstract syntax tree corresponding to the SQL to-be-processed is acquired, semantic parsing can be performed on the abstract syntax tree to obtain the processing logic between different tables, and the logical relationship between the at least two fields corresponding to the SQL to-be-processed is determined based on the processing logic.

Step 123: constructing the graphic representation corresponding to the SQL to-be-processed based on the plurality of tables, the association relationship between the plurality of tables, and the logical relationship between the at least two fields, so that the graphic representation can intuitively represent the plurality of tables, the association relationship between the plurality of tables, and the logical relationship between the at least two fields.

Based on the related content of the above steps 121-123, for the above SQL to-be-processed, after the abstract syntax tree corresponding to the SQL to-be-processed is acquired, semantic parsing is performed on the abstract syntax tree to obtain some tables involved in executing the SQL to-be-processed, an input-output relationship between these tables, and a logical relationship between different fields in these tables; then, the graphic representation corresponding to the SQL to-be-processed is constructed based on these pieces of information, so that the graphic representation can intuitively represent these pieces of information.

Based on the related content of the above S1, after the SQL to-be-processed is acquired, the SQL to-be-processed is parsed to obtain the graphic representation corresponding to the SQL to-be-processed, so that the graphic representation can intuitively describe the execution process of the SQL to-be-processed, and thus the graphic representation can describe the processing logic of various fields involved in executing the SQL to-be-processed in a visual manner, so that the processing logic of the field specified by the user can be determined subsequently with the aid of the graphic representation.

S2: cropping a graphic representation corresponding to a target field from the graphic representation corresponding to the SQL to-be-processed, where the graphic representation corresponding to the target field is used for describing the processing logic of the target field.

The target field refers to a field that exists in the at least one candidate field and needs to perform processing logic determination processing.

In addition, the present application does not limit the acquisition manner of the target field. For example, in some application scenarios, the target field is specified by the user in a certain way. It should be noted that the present application does not limit the specifying manner of the target field. For example, the user can specify the target field by inputting content, such as “submit” shown in FIG. 2, into an input box. For another example, the user can specify the target field by selecting a field from a certain list.

In addition, for the above target field, the graphic representation corresponding to the target field refers to a result obtained by cropping from the graphic representation corresponding to the SQL to-be-processed, such as the graphic representation of the field submit shown in FIG. 2, so that the graphic representation corresponding to the target field can intuitively describe the processing logic of the target field in a visual manner, and thus the graphic representation corresponding to the target field can represent how to process the target field when the SQL to-be-processed is executed.

In addition, the present application does not limit the implementation of the above S2. For example, it can specifically be: deleting a part unrelated to the target field, such as a part that has no influence on the target field, from the graphic representation corresponding to the SQL to-be-processed to obtain the graphic representation corresponding to the target field, so that the graphic representation corresponding to the target field can represent a part related to the target field, such as a part that can have an influence on the target field, existing in the graphic representation corresponding to the SQL to-be-processed.

Actually, in order to achieve better effect of field logic extraction, the present application further provides a possible implementation of the above S2. In this implementation, the S2 may specifically include the following steps 21-22.

Step 21: extracting an associated part of the target field from the graphic representation corresponding to the SQL to-be-processed.

The associated part of the target field refers to a part related to the target field existing in the graphic representation corresponding to the SQL to-be-processed, so that the associated part can represent a logic related to the target field involved in executing the SQL to-be-processed, such as a logic that uses the target field as a processing object, a logic involving a condition including the target field, and a logic that uses the target field as a generation object.

In addition, the implementation of the above step 21 is not limited in the present application. For example, it can specifically be: deleting a part unrelated to the target field from the graphic representation corresponding to the SQL to-be-processed to obtain the associated part of the target field.

Step 22: performing at least one type of simplification processing on the associated part of the target field to obtain the graphic representation corresponding to the target field, where the at least one type of simplification processing includes one or more of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

The at least one type of simplification processing is used for simplifying the processing logic described by the associated part of the target field, and the at least one type of simplification processing includes one or more of: invalid connection cropping processing, invalid field cropping processing, and nested selection combination processing.

The invalid connection cropping processing is used for simplifying the multi-table connection logic in the associated part of the target field, so that there is no table that cannot contribute to the target field in the simplified multi-table connection logic. The multi-table connection logic refers to a logic described by a certain join statement, such as a logic described by multiple segments of left join or a logic described by multiple segments of right join.

In addition, the implementation of the above invalid connection cropping processing is not limited in the present application. For example, it can be implemented according to a preset rule.

For another example, in order to achieve better processing effect, the above invalid connection cropping processing may specifically include the following steps 221-222.

Step 221: if the associated part of the target field includes left connection logic, and right table processing logic in the left connection logic has no influence on the target field, deleting the right table processing logic from the associated part.

The left connection logic refers to a logic described by a left join statement, such as a processing logic described by a SQL in the first column of the following Table 3.

The right table processing logic refers to a logic existing in the above left connection logic and used for processing the right table.

Based on the above step 221, for any left connection logic that appears in the associated part of the above target field, if the right table processing logic in the left connection logic has no influence on the target field, it can be determined that the right table cannot contribute to the target field, thereby it can be determined that there is an invalid connection in the left connection logic, so that the invalid connection, that is, the right table processing logic, can be directly deleted from the left connection logic, so that there is no invalid connection in the left connection logic after deletion, so that there is no table that cannot contribute to the target field in the left connection logic after deletion, thereby enabling the associated part including the left connection logic after deletion to more concisely describe how to process the target field. It should be noted that if the target field only appears in the associated condition involved in the left connection logic, such as the condition “on a.id=b.id”, whether simplification is required can be determined according to a specific scenario.

TABLE 3
Simplification examples of left join

| Before simplification | After simplification |
|---|---|
| select | select |
| a.xx1,b.xx2 | a.xx1,b.xx2 |
| from | from |
| ( | ( |
| select xx1 from t1 | select xx1 from t1 |
| ) a | ) a |
| left join | left join |
| ( | ( |
| select xx2 from t2 | select xx2 from t2 |
| ) b | ) b |
| left join | |
| ( | |
| select xx3 from t3 | |
| ) c | |

Step 222: if the associated part of the target field includes right connection logic, and left table processing logic in the right connection logic has no influence on the target field, deleting the left table processing logic from the associated part.

The right connection logic refers to a logic implemented with the aid of a right join statement.

The left table processing logic refers to a logic existing in the above right connection logic and used for processing the left table.

Based on the above step 222, for any right connection logic that appears in the associated part of the above target field, if the left table processing logic in the right connection logic has no influence on the target field, it can be determined that the left table cannot contribute to the target field, thereby it can be determined that there is an invalid connection in the right connection logic, so that the invalid connection, that is, the left table processing logic, can be directly deleted from the right connection logic, so that there is no invalid connection in the right connection logic after deletion, so that there is no table that cannot contribute to the target field in the right connection logic after deletion, thereby enabling the associated part including the right connection logic after deletion to more concisely describe how to process the target field. It should be noted that if the target field only appears in the associated condition involved in the right connection logic, whether simplification is required can be determined according to a specific scenario.

Based on the related content of the above steps 221-222, in some application scenarios, the invalid connection cropping processing can be performed on the associated part of the above target field to eliminate the invalid connection that appears in the associated part, which is beneficial to the improvement of the effect of field logic extraction.

The invalid field cropping processing is used for removing a field that has no influence on the target field from the associated part of the target field, and the implementation of the invalid field cropping processing is not limited in the present application. For example, the invalid field cropping processing may be implemented with the aid of a preset rule, so that the invalid field cropping processing can be used for only retaining a field and processing code that contribute to the target field, and/or the invalid field cropping processing may be used for only retaining the target field for caliber tracing, and performing cropping when other fields have no influence on the target field. It should be noted that all fields in the where condition need to be retained. In addition, whether on, group by, and lateral view need to be retained is determined according to a specific business scenario.

The nested selection combination processing is used for simplifying the multi-layer nested selection logic in the associated part of the target field. The multi-layer nested selection logic refers to a logic described by nesting multiple select statements, such as a logic described by a SQL in the first column of Table 4.

TABLE 4
Examples of nested selection combination processing

| Before simplification | After simplification |
|---|---|
| select | select |
| a | a |
| from | from |
| ( | t1 |
| select a from t1 where b = ‘’ | where b = ‘’ and a = ‘’ |
| ) | |
| where | |
| a = ‘’ | |
| select | select a1 as a from table1 |
| a | |
| from | |
| ( | |
| select a1 as a from table1 | |
| ) | |

In addition, the implementation of the nested selection combination processing is not limited in the present application. For example, it may specifically include the following steps 223-224.

Step 223: if the multi-layer nested selection logic in the associated part of the target field satisfies a predicate combination condition, combining at least two conditions in the associated part.

The predicate combination condition refers to a preset condition satisfied by the multi-layer nested selection logic capable of combining the where condition, such as a condition described in the second row of Table 4.

In addition, the implementation of the above step 223 is not limited in the application. For example, it may be: if the multi-layer nested selection logic in the associated part of the target field satisfies the predicate combination condition, combining at least two conditions in the associated part, so that the processing logic represented by the associated part after combination is consistent with the processing logic represented by the associated part before combination, and the number of SQL statements corresponding to the associated part after combination is less than the number of SQL statements corresponding to the associated part before combination. The number of SQL statements corresponding to the associated part after combination refers to the number of statements in a SQL obtained by performing inverse parse processing on the associated part after combination. The number of SQL statements corresponding to the associated part before combination refers to the number of statements in a SQL obtained by performing inverse parse processing on the associated part before combination.

Step 224: if the multi-layer nested selection logic in the associated part of the target field satisfies an invalid subquery combination condition, combining at least two layers of selection logic in the multi-layer nested selection logic in the associated part.

The invalid subquery combination condition refers to a preset condition satisfied by the multi-layer nested selection logic with an invalid subquery, such as a condition described in the third row of Table 4.

In addition, the implementation of the above step 224 is not limited in the present application. For example, it may specifically be: if the multi-layer nested selection logic in the associated part of the target field satisfies the invalid subquery combination condition, combining at least two layers of selection logic in the multi-layer nested selection logic into one layer of selection logic, such as deleting the invalid subquery corresponding to the invalid subquery combination condition from the multi-layer nested selection logic. The invalid subquery refers to a logic existing in the multi-layer nested selection logic that satisfies the invalid subquery combination condition and used for representing redundant semantics, such as a logic described by the deleted statement described in the third row of Table 4.

Based on the related content of the above steps 223-224, in some application scenarios, the nested selection combination processing can be performed on the associated part of the above target field, so as to eliminate the redundant logic that appears in the associated part, thereby facilitating the improvement of the effect of field logic extraction.

Based on the related content of the above steps 21-22, in a possible implementation, after the graphic representation corresponding to the SQL to-be-processed is acquired, the associated part of the target field is extracted from the graphic representation corresponding to the SQL to-be-processed, so that the associated part can represent the content related to the target field existing in the graphic representation corresponding to the SQL to-be-processed; then, at least one type of simplification processing is performed on the associated part to obtain the graphic representation corresponding to the target field, so that the graphic representation can represent the processing logic of the target field involved in executing the SQL to-be-processed as concisely as possible, which is beneficial to the improvement of the effect of field logic extraction.

Based on the related content of the above S2, after the graphic representation corresponding to the SQL to-be-processed is acquired, the graphic representation corresponding to the target field is crop from the graphic representation, so that the graphic representation can describe the processing logic of the target field involved in executing the SQL to-be-processed in a visual manner.

S3: performing inverse parse processing on the graphic representation corresponding to the target field to obtain a SQL corresponding to the target field.

The inverse parse processing refers to a reverse process of the “parse processing” in the above S1, so that the inverse parse processing can be used for restoring a graphic representation to a SQL.

In addition, the implementation of the above S3 is not limited in the present application. For example, it may specifically include: converting the graphic representation corresponding to the target field into an abstract syntax tree corresponding to the target field; and converting the abstract syntax tree corresponding to the target field into the SQL corresponding to the target field, so that the SQL corresponding to the target field can represent a query statement existing in the SQL to-be-processed and used for describing the processing logic of the target field.

Based on the related content of the above S1-S3, for the SQL processing method provided by the embodiments of the present application, after a SQL to-be-processed, such as a SQL input by a user, is acquired, parse processing is performed on the SQL to-be-processed to obtain a graphic representation corresponding to the SQL to-be-processed, so that the graphic representation is used for describing an execution process of the SQL to-be-processed, for example, the graphic representation can describe the execution process of the SQL to-be-processed in a visual manner; then, when the execution process includes processing logic of at least one candidate field and the at least one candidate field includes a target field, such as a field that needs to perform processing logic determination processing specified by the user, a graphic representation corresponding to the target field is crop from the graphic representation corresponding to the SQL to-be-processed, so that the graphic representation corresponding to the target field is used for describing the processing logic of the target field; finally, inverse parse processing is performed on the graphic representation corresponding to the target field to obtain a SQL corresponding to the target field, so that the SQL corresponding to the target field can represent the processing logic of the target field, and thus the processing logic of the target field can be completed by executing the SQL corresponding to the target field subsequently, and thus the processing logic of a certain field can be extracted from the SQL, thereby overcoming defects caused by manual extraction of the processing logic of the certain field effectively, such as time-consuming and low accuracy, thereby facilitating improvement of the effect of field logic extraction, such as extraction accuracy and extraction efficiency.

In addition, the present application does not limit the execution entity of the SQL processing method provided by the embodiments of the present application. For example, the SQL processing method provided by the embodiments of the present application can be applied to a terminal device. For another example, the SQL processing method provided by the embodiments of the present application can also be implemented with the aid of a data interaction process between a terminal device and a server. The terminal device can be a smart phone, a computer, a personal digital assistant (PDA), a tablet computer, etc. The server can be an independent server, a cluster server or a cloud server.

In addition, in order to achieve better improvement of user experience, the present application further provides a possible implementation of the SQL processing method. In this implementation, the SQL processing method may further include the following step 31.

Step 31: displaying the SQL corresponding to the target field and the graphic representation corresponding to the target field.

In the present application, after the SQL corresponding to the target field and the graphic representation corresponding to the target field are acquired, both can be displayed to the user, so that the user can learn the processing logic of the target field involved in executing the SQL to-be-processed from multiple perspectives, such as a SQL perspective and a visualization perspective, which is beneficial to the improvement of user experience.

In addition, in some application scenarios, a physical table that appears in a SQL may be generated by executing other SQLs. Therefore, in order to achieve better improvement of the effect of field logic extraction, the present application further provides a possible implementation of the SQL processing method. In this implementation, the SQL processing method may include the following steps 41-44.

Step 41: performing parse processing on a SQL to-be-processed to obtain a graphic representation corresponding to the SQL to-be-processed after the SQL to-be-processed is acquired, where the graphic representation is used for describing an execution process of the SQL to-be-processed, the execution process includes processing logic of at least one candidate field, and the at least one candidate field includes a target field.

It should be noted that, for the related content of step 41, please refer to the above S1.

Step 42: cropping a graphic representation corresponding to a target field from the graphic representation corresponding to the SQL to-be-processed, where the graphic representation corresponding to the target field is used for describing the processing logic of the target field.

It should be noted that, for the related content of step 42, please refer to the above S2.

Step 43: performing inverse parse processing on the graphic representation corresponding to the target field to obtain the SQL corresponding to the target field.

It should be noted that, for the related content of step 43, please refer to the above S3.

Step 44: updating the SQL to-be-processed according to the SQL corresponding to the target field and a production SQL of a physical table in the SQL corresponding to the target field, and returning to continue performing the step of performing parse processing on the SQL to-be-processed in the above step 41 and subsequent steps thereof, until a preset stop condition is reached.

The production SQL of the physical table is used for describing how the physical table is generated. It can be seen that the physical table is obtained by executing the production SQL. For example, for the various databases shown in FIG. 3, each physical table in a data warehouse middle (DWM) is obtained by processing some physical tables in a data warehouse detail (DWD); and each physical table in the DWD is obtained by processing some physical tables in an operational data store (ODS). It should be noted that the physical tables in the SQL involved in an application layer (APP) usually come from the DWM.

In addition, the present application does not limit the implementation of the above production SQL. For example, it can be statements such as with, insert, cache table, and the like.

In addition, the present application does not limit the implementation of the updating in the above step 44. For example, in order to achieve better improvement of SQL processing effect, the step 44 may specifically include the following steps 441-442.

Step 441: performing deformation processing on the production SQL of the physical table in the SQL corresponding to the target field to obtain a subquery statement corresponding to the physical table, where the processing logic described by the subquery statement is consistent with the processing logic described by the production SQL.

The subquery statement corresponding to the physical table is used for representing, with the aid of a select statement, the logic described by the production SQL of the physical table, so as to implement conversion of the production SQL into the subquery statement.

In addition, the implementation of the “deformation processing” in the above step 441 is not limited in the present application. For example, it can be implemented with the aid of a preset deformation rule.

Step 442: replacing the physical table in the SQL corresponding to the target field with the subquery statement corresponding to the physical table to obtain an updated SQL to-be-processed.

In the present application, for the physical table in the SQL corresponding to the target field, after the subquery statement corresponding to the physical table is acquired, the corresponding physical table in the SQL corresponding to the target field can be directly replaced with the subquery statement corresponding to the physical table, to obtain the updated SQL to-be-processed, so that the updated SQL to-be-processed does not include the physical table, but includes the subquery statement corresponding to the physical table, thereby enabling upward exploration of the physical table, which is beneficial to better meet the requirements of the user. The subquery statement corresponding to the physical table represents the logic described by the production SQL of the physical table with the aid of the select statement, so that the subquery statement corresponding to the physical table is more suitable for the SQL corresponding to the target field, thereby avoiding problems caused by incompatibility between diverse production SQLs and the SQL corresponding to the target field effectively, which is beneficial to the improvement of the effect of field logic extraction.

Based on the related content of the above steps 441-442, after the SQL corresponding to the target field is acquired, some physical tables involved in the SQL corresponding to the target field can be replaced with query statements capable of describing the processing logic of these physical tables, so as to implement upward exploration of the physical table, which is beneficial to better meet the requirements of the user.

The preset stop condition refers to a condition that needs to be based on when stopping an iteration process, and the preset stop condition is not limited in the present application. For example, the preset stop condition can be determined according to the constraint information for the number of upward exploration layers provided by the user. The constraint for the number of upward exploration layers is used for representing the number of upward exploration layers, and the constraint for the number of upward exploration layers is not limited in the present application. For example, it may include a character string “upward exploration to DWD”.

Based on the related content of the above steps 41-44, the present application further supports upward exploration of some physical tables based on the cropping of SQL, to acquire query statements capable of describing the processing logic of these physical tables, thereby better meeting the requirements of the user.

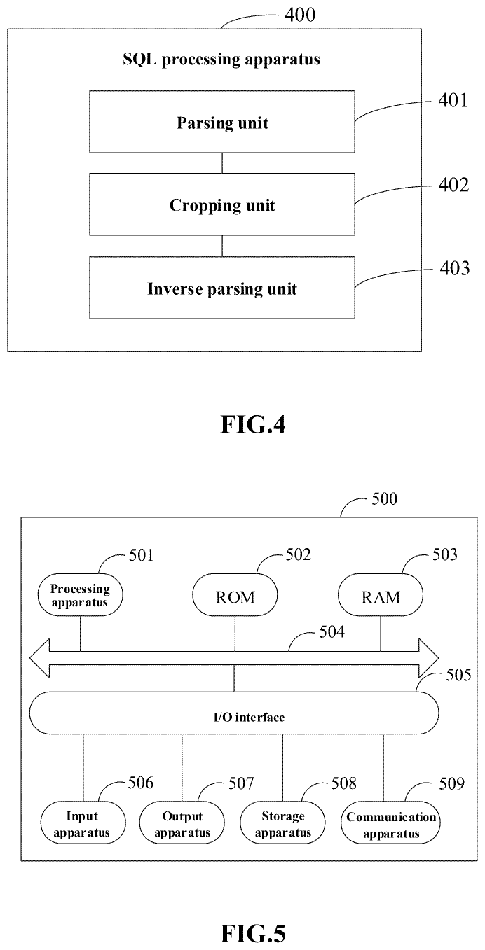

Based on the SQL processing method provided by the embodiments of the present application, the embodiments of the present application further provide a SQL processing apparatus, which will be explained and described below with reference to FIG. 4. FIG. 4 is a schematic structural diagram of a SQL processing apparatus provided by an embodiment of the present application. It should be noted that, for the technical details of the SQL processing apparatus provided by the embodiments of the present application, please refer to the related content of the above SQL processing method.

As shown in FIG. 4, the SQL processing apparatus 400 provided by the embodiments of the present application includes:

a parsing unit 401, configured to perform parse processing on a SQL to-be-processed to obtain a graphic representation corresponding to the SQL to-be-processed after the SQL to-be-processed is acquired, where the graphic representation is used for describing an execution process of the SQL to-be-processed, the execution process includes processing logic of at least one candidate field, and the at least one candidate field includes a target field;

a cropping unit 402, configured to crop a graphic representation corresponding to the target field from the graphic representation corresponding to the SQL to-be-processed, where the graphic representation corresponding to the target field is used for describing the processing logic of the target field; and

an inverse parsing unit 403, configured to perform inverse parse processing on the graphic representation corresponding to the target field to obtain a SQL corresponding to the target field.

In one possible implementation, the parsing unit 401 is specifically configured to: convert the SQL to-be-processed into an abstract syntax tree corresponding to the SQL to-be-processed; convert the abstract syntax tree corresponding to the SQL to-be-processed into the graphic representation corresponding to the SQL to-be-processed;

the inverse parsing unit 403 is specifically configured to: convert the graphic representation corresponding to the target field into an abstract syntax tree corresponding to the target field; convert the abstract syntax tree corresponding to the target field into the SQL corresponding to the target field.

In one possible implementation, the cropping unit 402 is specifically configured to: extract an associated part of the target field from the graphic representation corresponding to the SQL to-be-processed; and perform at least one type of simplification processing on the associated part to obtain the graphic representation corresponding to the target field, where the at least one type of simplification processing includes at least one of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

In one possible implementation, the invalid connection cropping processing includes: in response to the associated part including left connection logic, and right table processing logic in the left connection logic having no influence on the target field, deleting the right table processing logic from the associated part; and in response to the associated part including right connection logic, and left table processing logic in the right connection logic having no influence on the target field, deleting the left table processing logic from the associated part.

In one possible implementation, the nested selection combination processing includes: in response to the multi-layer nested selection logic in the associated part satisfying a predicate combination condition, combining at least two conditions in the multi-layer nested selection logic; and in response to the multi-layer nested selection logic in the associated part satisfying an invalid subquery combination condition, combining at least two layers of selection logic in the multi-layer nested selection logic.

In one possible implementation, the SQL processing apparatus 400 further includes:
a display unit, configured to display the SQL corresponding to the target field and the graphic representation corresponding to the target field.

In one possible implementation, the SQL processing apparatus 400 further includes:
an update unit, configured to update the SQL to-be-processed according to the SQL corresponding to the target field and a production SQL of a physical table in the SQL corresponding to the target field, and return to continue performing the step of performing parse processing on the SQL to-be-processed, until a preset stop condition is reached, where the physical table is obtained by executing the production SQL.

In one possible implementation, the update unit is specifically configured to: perform deformation processing on the production SQL of the physical table to obtain a subquery statement corresponding to the physical table, where the processing logic described by the subquery statement is consistent with the processing logic described by the production SQL; and replace the physical table in the SQL corresponding to the target field with the subquery statement corresponding to the physical table to obtain an updated SQL to-be-processed.

Based on the related content of the above SQL processing apparatus 400, for the SQL processing apparatus 400 provided by the embodiments of the present application, after a SQL to-be-processed, such as a SQL input by a user, is acquired, parse processing is performed on the SQL to-be-processed to obtain a graphic representation corresponding to the SQL to-be-processed, so that the graphic representation is used for describing an execution process of the SQL to-be-processed, for example, the graphic representation can describe the execution process of the SQL to-be-processed in a visual manner; then, when the execution process includes processing logic of at least one candidate field and the at least one candidate field includes a target field, such as a field that needs to perform processing logic determination processing specified by the user, a graphic representation corresponding to the target field is crop from the graphic representation corresponding to the SQL to-be-processed, so that the graphic representation corresponding to the target field is used for describing the processing logic of the target field; finally, inverse parse processing is performed on the graphic representation corresponding to the target field to obtain a SQL corresponding to the target field, so that the SQL corresponding to the target field can represent the processing logic of the target field, and thus the processing logic of the target field can be completed by executing the SQL corresponding to the target field subsequently, and thus the processing logic of a certain field can be extracted from the SQL, thereby overcoming defects caused by manual extraction of the processing logic of the certain field effectively, such as time-consuming and low accuracy, thereby facilitating improvement of the effect of field logic extraction, such as extraction accuracy and extraction efficiency.

In addition, an embodiment of the present application further provides an electronic device, the device includes a processor and a memory, the memory is configured to store instructions or a computer program, and the processor is configured to execute the instructions or the computer program in the memory, to enable the electronic device to execute any implementation of the SQL processing method provided by the embodiments of the present application.

FIG. 5 is a schematic structural diagram of an electronic device 500 suitable for implementing an embodiment of the present application. The terminal device in this embodiment of the present application may include, but is not limited to, a mobile terminal such as a mobile phone, a notebook computer, a digital broadcast receiver, a personal digital assistant (PDA), a tablet computer, a portable multimedia player (PMP), a vehicle-mounted terminal (such as a vehicle-mounted navigation terminal), etc., and a fixed terminal such as a digital TV, a desktop computer, etc. The electronic device shown in FIG. 5 is merely an example, and shall not impose any limitation on the function and scope of use of the embodiments of the present application.

As shown in FIG. 5, the electronic device 500 may include a processing apparatus (e.g., a central processing unit, a graphics processing unit, etc.) 501 that can perform various suitable actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses can be connected to the I/O interface 505: an input apparatus 506 including, for example, a touch screen, a touchpad, a keyboard, a mouse, a camera, a microphone, an accelerometer, a gyroscope, or the like; an output apparatus 507 including, for example, a liquid crystal display (LCD), a speaker, a vibrator, or the like; the storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may alternatively be implemented or included.

In particular, according to an embodiment of the present application, the processes described above with reference to the flowcharts can be implemented as a computer software program. For example, an embodiment of the present application includes a computer program product, which includes a computer program carried on a non-transitory computer-readable medium, and the computer program includes program codes for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above-mentioned functions defined in the methods of the embodiments of the present application are performed.

The electronic device provided by the embodiments of the present application belongs to the same inventive concept as the method provided by the above embodiments. For technical details not described in detail in this embodiment, reference may be made to the above embodiments, and this embodiment has the same beneficial effects as the above embodiments.

An embodiment of the present application further provides a computer-readable medium. The computer-readable medium stores instructions or a computer program. When the instructions or the computer program are run on a device, the device is enabled to execute any implementation of the SQL processing method provided by the embodiments of the present application.

It should be noted that the above computer-readable medium in the present application may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In the present application, the computer-readable storage medium may be any tangible medium containing or storing a program that can be used by or in combination with an instruction execution system, apparatus, or device. In the present application, the computer-readable signal medium may include a data signal propagated in a baseband or as a part of a carrier wave, in which computer-readable program codes are carried. The data signal propagated in this manner may take a variety of forms, including but not limited to an electromagnetic signal, an optical signal, or any suitable combination thereof. The computer-readable signal medium may further be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to: a wire, an optical cable, a radio frequency (RF), etc., or any suitable combination thereof.

In some implementations, clients and servers can communicate using any currently known or future-developed network protocol, such as the Hypertext transfer protocol (HTTP), and can be interconnected with any form or medium of digital data communication (for example, a communication network). Examples of the communication network include a local area network (“LAN”), a wide area network (“WAN”), an internet (for example, the Internet), and an end-to-end network (for example, an ad hoc end-to-end network), as well as any currently known or future-developed networks.

The computer-readable medium may be included in the electronic device or may exist alone without being assembled into the electronic device.

The computer-readable medium carries one or more programs, and when the one or more programs are executed by the electronic device, the electronic device can execute the above methods.

The computer program codes for performing the operations of the present application can be written in one or more programming languages or a combination thereof. The above programming languages include, but are not limited to, object-oriented programming languages such as Java, Smalltalk, C++, and also conventional procedural programming languages such as “C” language or similar programming languages. The program code can be executed completely on the user's computer, partially on the user's computer, as an independent software package, partially on the user's computer and partially on a remote computer, or completely on the remote computer or server. In the case of involving a remote computer, the remote computer can be connected to the user's computer through any kind of network, including a local area network (LAN) or a wide area network (WAN), or can be connected to an external computer (for example, connected via the Internet through an Internet service provider).

The flowcharts and block diagrams in the drawings illustrate the possible architecture, function, and operation of the system, method, and computer program product according to various embodiments of the present application. In this regard, each block in the flowchart or block diagram may represent a module, a program segment, or a part of code, and the module, program segment, or part of code contains one or more executable instructions for implementing the specified logical function. It should also be noted that in some alternative implementations, the functions marked in the blocks may also occur in a different order from the order marked in the drawings. For example, two blocks shown in succession can actually be executed substantially in parallel, and they can sometimes be executed in the reverse order, depending on the functions involved. It should also be noted that each block in the block diagram and/or flowchart, and the combination of blocks in the block diagram and/or flowchart, can be implemented by a dedicated hardware-based system that performs the specified functions or operations, or can be implemented by a combination of dedicated hardware and computer instructions.

The units involved in the embodiments of the present application can be implemented in software or hardware. The name of the unit/module does not constitute a limitation on the unit itself under certain circumstances.

The functions described above in this document can be performed at least in part by one or more hardware logic components. For example, without limitation, exemplary types of hardware logic components that can be used include: field Programmable Gate Array (FPGA), Application Specific Integrated Circuit (ASIC), Application Specific Standard Product (ASSP), System on Chip (SOC), Complex Programmable Logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that, the embodiments in the present description are described in a progressive manner, and each embodiment focuses on differences from other embodiments, and the same or similar parts between the embodiments may be referred to each other. For the system or apparatus disclosed in the embodiments, since it corresponds to the method disclosed in the embodiments, the description thereof is relatively simple, and reference may be made to the description of the method part for related parts.

It should be understood that, in the present application, “at least one” means one or more, and “multiple” means two or more. “And/or” is used to describe an association relationship between associated objects, and indicates that there may be three relationships. For example, “A and/or B” may mean that there are three cases: only A exists, only B exists, and both A and B exist at the same time, where A and B may be singular or plural. The character “/” generally indicates that the associated objects before and after are in an “or” relationship. “At least one of the following items” or similar expressions refer to any combination of these items, including any combination of a single item or plural items. For example, at least one of a, b, or c may mean: a, b, c, “a and b”, “a and c”, “b and c”, or “a and b and c”, where a, b, and c may be singular or plural.

It should be further noted that, in this document, relational terms such as first and second are only used to distinguish one entity or operation from another entity or operation, and do not necessarily require or imply any such actual relationship or order between these entities or operations. Moreover, the term “includes”, “include”, or any other variant thereof is intended to cover a non-exclusive inclusion, so that a process, method, article, or device that includes a series of elements includes not only those elements, but also other elements that are not explicitly listed, or elements that are inherent to such process, method, article, or device. Without further limitation, an element defined by the statement “include one . . . ” does not exclude the presence of additional identical elements in the process, method, article, or device that includes the element.

The steps of the methods or algorithms described in conjunction with the embodiments disclosed herein can be implemented directly in hardware, in a software module executed by a processor, or in a combination of both. The software module can be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the disclosed embodiments enables those skilled in the art to implement or use the present application. Various modifications to these embodiments will be obvious to those skilled in the art, and the general principles defined herein can be implemented in other embodiments without departing from the spirit or scope of the present application. Therefore, the present application will not be limited to the embodiments shown herein, but will conform to the widest scope consistent with the principles and novel features disclosed herein.

I/We claim:

1. A SQL processing method, comprising:
performing parse processing on a SQL to-be-processed to obtain a graphic representation corresponding to the SQL to-be-processed after the SQL to-be-processed is acquired, the graphic representation being used for describing an execution process of the SQL to-be-processed, the execution process comprises processing logic of at least one candidate field, and the at least one candidate field comprises a target field;
cropping a graphic representation corresponding to the target field from a graphic representation corresponding to the SQL to-be-processed, the graphic representation corresponding to the target field being used for describing processing logic of the target field; and
performing inverse parse processing on the graphic representation corresponding to the target field to obtain a SQL corresponding to the target field.

2. The method of claim 1, wherein a process for determining the graphic representation corresponding to the SQL to-be-processed comprises:
converting the SQL to-be-processed into an abstract syntax tree corresponding to the SQL to-be-processed; and
converting the abstract syntax tree corresponding to the SQL to-be-processed into the graphic representation corresponding to the SQL to-be-processed;
wherein a process for determining the SQL corresponding to the target field comprises:
converting the graphic representation corresponding to the target field into an abstract syntax tree corresponding to the target field; and
converting the abstract syntax tree corresponding to the target field into the SQL corresponding to the target field.

3. The method of claim 1, wherein cropping the graphic representation corresponding to the target field from the graphic representation corresponding to the SQL to-be-processed comprises:
extracting an associated part of the target field from the graphic representation corresponding to the SQL to-be-processed; and
performing at least one type of simplification processing on the associated part to obtain the graphic representation corresponding to the target field, wherein the at least one type of simplification processing comprises one or more of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

4. The method of claim 3, wherein the invalid connection cropping processing comprises:
in response to the associated part comprising left connection logic and right table processing logic in the left connection logic having no influence on the target field, deleting the right table processing logic from the associated part; and
in response to the associated part comprising right connection logic and left table processing logic in the right connection logic having no influence on the target field, deleting the left table processing logic from the associated part.

5. The method of claim 3, wherein the nested selection combination processing comprises:
in response to the multi-layer nested selection logic in the associated part satisfying a predicate combination condition, combining at least two conditions in the multi-layer nested selection logic; and
in response to the multi-layer nested selection logic in the associated part satisfying an invalid subquery combination condition, combining at least two layers of selection logic in the multi-layer nested selection logic.

6. The method of claim 1, further comprising:
displaying the SQL corresponding to the target field and the graphic representation corresponding to the target field.

7. The method of claim 1, further comprising: after obtaining the SQL corresponding to the target field,
updating the SQL to-be-processed according to the SQL corresponding to the target field and a production SQL of a physical table in the SQL corresponding to the target field, and returning to continue performing parse processing on the SQL to-be-processed, until a preset stop condition is satisfied, wherein the physical table is obtained by executing the production SQL.

8. The method of claim 7, wherein updating the SQL to-be-processed according to the SQL corresponding to the target field and the production SQL of the physical table in the SQL corresponding to the target field comprises:
performing deformation processing on the production SQL of the physical table to obtain a subquery statement corresponding to the physical table, wherein processing logic described by the subquery statement is consistent with processing logic described by the production SQL; and
replacing the physical table in the SQL corresponding to the target field with the subquery statement corresponding to the physical table to obtain an updated SQL to-be-processed.

9. An electronic device, comprising: a processor and a memory;
wherein the memory is configured to store instructions or a computer program; and
the processor is configured to execute the instructions or the computer program in the memory, to cause the electronic device to:
perform parse processing on a SQL to-be-processed to obtain a graphic representation corresponding to the SQL to-be-processed after the SQL to-be-processed is acquired, the graphic representation being used for describing an execution process of the SQL to-be-processed, the execution process comprises processing logic of at least one candidate field, and the at least one candidate field comprises a target field;
crop a graphic representation corresponding to the target field from a graphic representation corresponding to the SQL to-be-processed, the graphic representation corresponding to the target field being used for describing processing logic of the target field; and
perform inverse parse processing on the graphic representation corresponding to the target field to obtain a SQL corresponding to the target field.

10. The electronic device of claim 9, wherein a process for determining the graphic representation corresponding to the SQL to-be-processed comprises:
converting the SQL to-be-processed into an abstract syntax tree corresponding to the SQL to-be-processed; and
converting the abstract syntax tree corresponding to the SQL to-be-processed into the graphic representation corresponding to the SQL to-be-processed;
wherein a process for determining the SQL corresponding to the target field comprises:
converting the graphic representation corresponding to the target field into an abstract syntax tree corresponding to the target field; and
converting the abstract syntax tree corresponding to the target field into the SQL corresponding to the target field.

11. The electronic device of claim 9, wherein the electronic device is caused to crop the graphic representation corresponding to the target field from the graphic representation corresponding to the SQL to-be-processed by being caused to:
extract an associated part of the target field from the graphic representation corresponding to the SQL to-be-processed; and
perform at least one type of simplification processing on the associated part to obtain the graphic representation corresponding to the target field, wherein the at least one type of simplification processing comprises one or more of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

12. The electronic device of claim 11, wherein the invalid connection cropping processing comprises:
in response to the associated part comprising left connection logic and right table processing logic in the left connection logic having no influence on the target field, deleting the right table processing logic from the associated part; and
in response to the associated part comprising right connection logic and left table processing logic in the right connection logic having no influence on the target field, deleting the left table processing logic from the associated part.

13. The electronic device of claim 11, wherein the nested selection combination processing comprises:
in response to the multi-layer nested selection logic in the associated part satisfying a predicate combination condition, combining at least two conditions in the multi-layer nested selection logic; and
in response to the multi-layer nested selection logic in the associated part satisfying an invalid subquery combination condition, combining at least two layers of selection logic in the multi-layer nested selection logic.

14. The electronic device of claim 9, wherein the electronic device is further caused to:
display the SQL corresponding to the target field and the graphic representation corresponding to the target field.

15. The electronic device of claim 9, wherein the electronic device is further caused to: after obtaining the SQL corresponding to the target field,
update the SQL to-be-processed according to the SQL corresponding to the target field and a production SQL of a physical table in the SQL corresponding to the target field, and return to continue performing parse processing on the SQL to-be-processed, until a preset stop condition is satisfied, wherein the physical table is obtained by executing the production SQL.

16. The electronic device of claim 15, wherein the electronic device is caused to update the SQL to-be-processed according to the SQL corresponding to the target field and the production SQL of the physical table in the SQL corresponding to the target field by being caused to:
perform deformation processing on the production SQL of the physical table to obtain a subquery statement corresponding to the physical table, wherein processing logic described by the subquery statement is consistent with processing logic described by the production SQL; and
replace the physical table in the SQL corresponding to the target field with the subquery statement corresponding to the physical table to obtain an updated SQL to-be-processed.

17. A non-transitory computer-readable medium, wherein the computer-readable medium stores instructions or a computer program, and when the instructions or the computer program are run on a device, the device is caused to:
perform parse processing on a SQL to-be-processed to obtain a graphic representation corresponding to the SQL to-be-processed after the SQL to-be-processed is acquired, the graphic representation being used for describing an execution process of the SQL to-be-processed, the execution process comprises processing logic of at least one candidate field, and the at least one candidate field comprises a target field;
crop a graphic representation corresponding to the target field from a graphic representation corresponding to the SQL to-be-processed, the graphic representation corresponding to the target field being used for describing processing logic of the target field; and
perform inverse parse processing on the graphic representation corresponding to the target field to obtain a SQL corresponding to the target field.

18. The non-transitory computer-readable medium of claim 17, wherein a process for determining the graphic representation corresponding to the SQL to-be-processed comprises:
converting the SQL to-be-processed into an abstract syntax tree corresponding to the SQL to-be-processed; and
converting the abstract syntax tree corresponding to the SQL to-be-processed into the graphic representation corresponding to the SQL to-be-processed;
wherein a process for determining the SQL corresponding to the target field comprises:
converting the graphic representation corresponding to the target field into an abstract syntax tree corresponding to the target field; and
converting the abstract syntax tree corresponding to the target field into the SQL corresponding to the target field.

19. The non-transitory computer-readable medium of claim 17, wherein the device is caused to crop the graphic representation corresponding to the target field from the graphic representation corresponding to the SQL to-be-processed by being caused to:
extract an associated part of the target field from the graphic representation corresponding to the SQL to-be-processed; and
perform at least one type of simplification processing on the associated part to obtain the graphic representation corresponding to the target field, wherein the at least one type of simplification processing comprises one or more of: invalid connection cropping processing, invalid field cropping processing, and nested selection combination processing, the invalid connection cropping processing is used for simplifying multi-table connection logic in the associated part, the invalid field cropping processing is used for removing a field that has no influence on the target field from the associated part, and the nested selection combination processing is used for simplifying multi-layer nested selection logic in the associated part.

20. The non-transitory computer-readable medium of claim 19, wherein the invalid connection cropping processing comprises:
in response to the associated part comprising left connection logic and right table processing logic in the left connection logic having no influence on the target field, deleting the right table processing logic from the associated part; and
in response to the associated part comprising right connection logic and left table processing logic in the right connection logic having no influence on the target field, deleting the left table processing logic from the associated part.
